(19) United States
(12) Patent Application Publication
(10) Pub. No.: US 2024/0403058 A1
(43) Pub. Date: Dec. 5, 2024

(54) IN-VEHICLE DEVICE AND METHOD TO BE EXECUTED BY IN-VEHICLE DEVICE

(71) Applicant: TOYOTA JIDOSHA KABUSHIKI KAISHA, Toyota-shi (JP)

(72) Inventor: Kunihiro MURAKAMI, Okazaki-shi (JP)

(73) Assignee: TOYOTA JIDOSHA KABUSHIKI KAISHA, Toyota-shi (JP)

(21) Appl. No.: 18/624,243

(22) Filed: Apr. 2, 2024

(30) Foreign Application Priority Data
Jun. 2, 2023 (JP) 2023-091907

(51) Int. Cl. G06F 9/38; G06F 9/30

(52) U.S. Cl. CPC G06F 9/3851; G06F 9/3009

(57) ABSTRACT

The in-vehicle device processes one process by a plurality of threads. The process is configured to perform at least three N tasks, and the process is configured to process the N tasks by dividing them into threats fewer than N threads.

### CROSS-REFERENCE TO RELATED APPLICATION

This application claims priority to Japanese Patent Application No. 2023-091907 filed on Jun. 2, 2023, incorporated herein by reference in its entirety.

### BACKGROUND

### 1. Technical Field

The present disclosure relates to an in-vehicle device and a method to be executed by the in-vehicle device.

### 2. Description of Related Art

Hitherto, functions such as a remote control function of a vehicle are performed by a dedicated microcontroller out of a plurality of microcontrollers mounted on the vehicle. For example, Japanese Unexamined Patent Application Publication No. 2020-125050 (JP 2020-125050 A) discloses that a vehicle starts a pre-air-conditioning operation in response to an operation performed on a remote control device.

### SUMMARY

In next-generation vehicles such as motor vehicles using electric power as a power source, part of functions of the vehicle, such as a remote control function, is managed collectively by an operating system (OS) of an in-vehicle device without using a dedicated microcontroller. In this case, there is room for improvement in the technology of in-vehicle devices for vehicles.

An object of the present disclosure made in view of such circumstances is to improve the technology of in-vehicle devices for the next-generation vehicles.

An in-vehicle device according to an embodiment of the present disclosure is an in-vehicle device configured to execute one process in a plurality of threads. The process is configured to execute N tasks that are at least three tasks, and process the N tasks in a plurality of threads fewer than the N tasks.

A method according to an embodiment of the present disclosure is a method to be executed by an in-vehicle device configured to execute one process in a plurality of threads.

The process is configured to execute N tasks that are at least three tasks.

The method includes processing the N tasks in a plurality of threads fewer than the N tasks.

According to an embodiment of the present disclosure, the technology of in-vehicle devices for next-generation vehicles is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment of the present disclosure;

FIG. 2 is a block diagram illustrating a schematic hardware configuration of an in-vehicle device;

FIG. 3 is a block diagram illustrating a schematic software configuration of an in-vehicle device;

FIG. 4 is an exemplary process for comparing with the process of the in-vehicle device according to the present embodiment; and

FIG. 5 is a diagram illustrating a process of the in-vehicle device according to the present embodiment.

### DETAILED DESCRIPTION OF EMBODIMENTS

Hereinafter, an embodiment of the present disclosure will be described.

### Outline of Embodiment

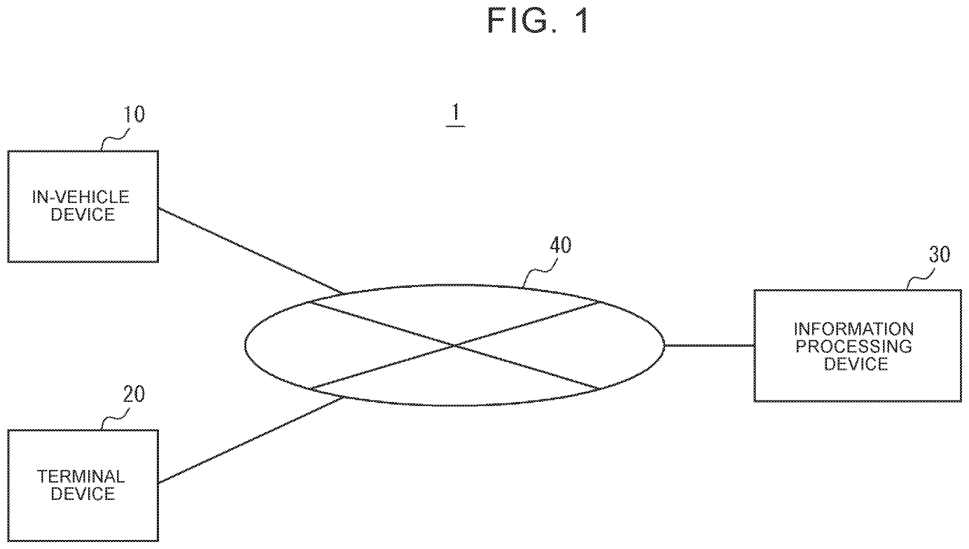

The outline of a system 1 according to an embodiment of the present disclosure will be described with reference to FIG. 1. The system 1 includes an in-vehicle device 10, a terminal device 20, and an information processing device 30. The in-vehicle device 10, the terminal device 20, and the information processing device 30 are communicably connected to a network 40 including, for example, the Internet and a mobile communication network.

The in-vehicle device 10 is a computer mounted on a vehicle. The computer is equipped with an OS. The vehicle is, for example, an automobile, but is not limited thereto, and may be any vehicle. Vehicles are motor vehicles powered by electrical power, such as, but not limited to, Battery Electric Vehicle (BEV), Hybrid Electric Vehicle (HEV), Plug-in Hybrid Electric Vehicle (PHEV), or Fuel Cell Electric Vehicle (FCEV).

The terminal device 20 is, for example, a Personal Computer (PC), a computer such as a smart phone or a bullet terminal, or a dedicated device having a function as a key of the vehicle, and is a vehicle portable device such as a key phone, a smart key, a key card, or the like. In the present embodiment, the terminal device 20 is capable of communicating with the in-vehicle device 10, and is used by a user such as a driver of a vehicle, for example, to remotely control the vehicle.

The information processing device 30 is, for example, a computer such as a server device. The information processing device 30 can communicate with the in-vehicle device 10 and the terminal device 20 via the network 40.

First, the outline of the present embodiment will be described, and the details will be described later. The in-vehicle device 10 processes one process by a plurality of threads. The process is configured to perform N tasks that are at least three, and is configured to process the N tasks by dividing them into threads fewer than N threads.

As described above, according to the present embodiment, during the operation of the process, since N tasks are processed by dividing them into a plurality of threads smaller than N, the number of inter-thread communication is reduced as compared with a configuration in which, for example, N tasks are processed by dividing them into N threads. As a result, the execution speed of the process may be higher than that of the in-vehicle device without the present embodiment. Therefore, according to the present embodiment, the technology of the in-vehicle device of the next-generation vehicle is improved in that the execution speed of the process can be improved.

Next, each configuration of the system 1 will be described in detail.

### Hardware Configuration of the In-Vehicle Device

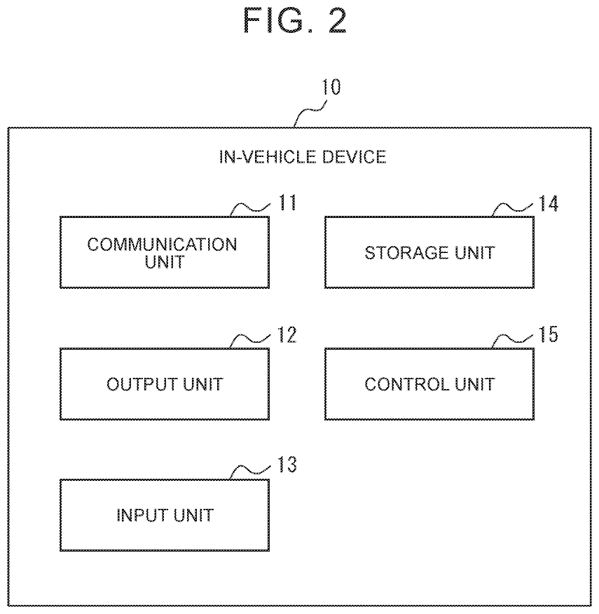

As illustrated in FIG. 2, the in-vehicle device 10 includes a communication unit 11, an output unit 12, an input unit 13, a storage unit 14, and a control unit 15.

The communication unit 11 includes one or more communication interfaces connected to the network 40. The communication interfaces correspond to mobile communication standards such as 4th Generation (4G) or 5th Generation (5G), for example, but are not limited thereto. In the present embodiment, the in-vehicle device 10 communicates with the terminal device 20 and the information processing device 30 via the communication unit 11 and the network 40.

The output unit 12 includes one or more output devices for outputting information. The output device is, for example, a display that outputs information by video, a speaker that outputs information by sound, or the like, but is not limited thereto. Alternatively, the output unit 12 may include an interface for connecting an external output device.

The input unit 13 includes one or more input devices that detect an input operation by a user. The input device is, for example, a physical key, a capacitive key, a mouse, a touch panel, a touch screen integrally provided with a display of the output unit 12, a microphone, or the like, but is not limited thereto. Alternatively, the input unit 13 may include an interface for connecting an external input device.

The storage unit 14 includes one or more memories. The memories are, for example, a semiconductor memory, a magnetic memory, or an optical memory, but are not limited to these memories. Each memory included in the storage unit 14 may function as, for example, a main storage device, an auxiliary storage device, or a cache memory. For example, the storage unit 14 may store a system program, an application program, and embedded software. For example, the information stored in the storage unit 14 may be updatable by, for example, information acquired from the network 40 via the communication unit 11.

The control unit 15 includes one or more processors, one or more programmable circuits, one or more dedicated circuits, or a combination of these. The processor may be, but is not limited to, a general-purpose processor such as, for example, Central Processing Unit (CPU) or Graphics Processing Unit (GPU), or a special-purpose processor specialized for a particular process. The programmable circuitry is, for example, but not limited to, Field-Programmable Gate Array (FPGA). The dedicated circuitry is, for example, but not limited to, Application Specific Integrated Circuit (ASIC). The control unit 15 controls the operation of the entire vehicle including the in-vehicle device 10.

### Software Configuration of the In-Vehicle Device

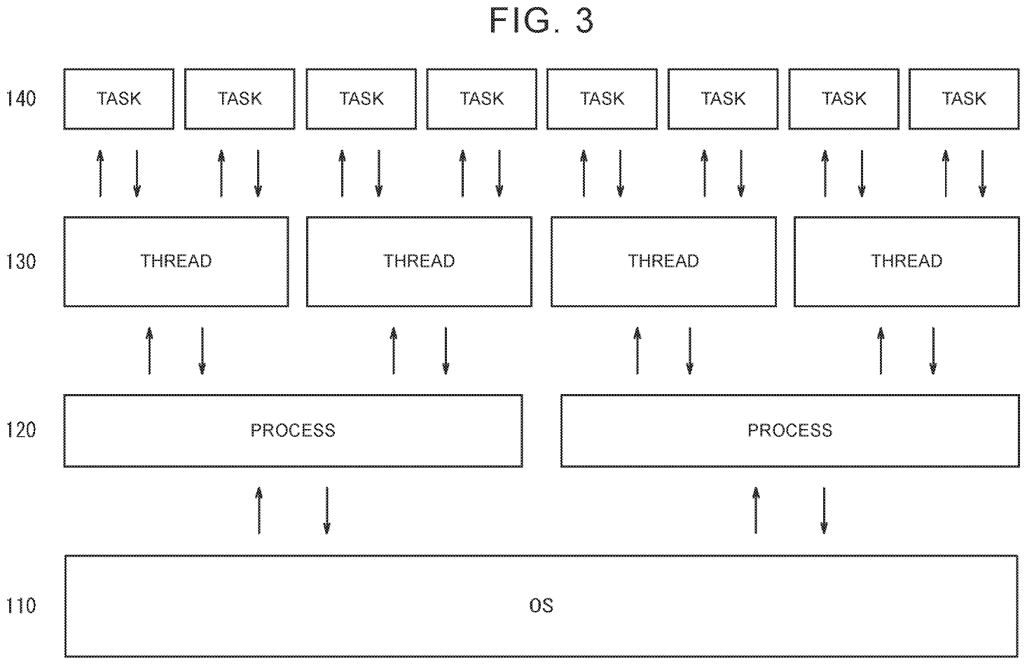

As illustrated in FIG. 3, the in-vehicle device 10 includes a OS 110, a plurality of processes 120, a plurality of threads 130, and a plurality of tasks 140.

OS 110 manages the execution of processes 120, the execution of threads 130, and the execution of tasks 140. OS 110 include, but are not limited to, OS such as Microsoft Windows (registered trademark), UNIX (registered trademark), Solaris (registered trademark), LINUX (registered trademark), Apple (registered trademark), MAC-OS (registered trademark), Apple IOS (registered trademark), and the like.

In the present embodiment, the process 120 is generated by a user operation on the terminal device 20, a timer activation, or any other trigger. Specifically, a process generated in response to a user operation on the terminal device 20 includes, for example, a process generated in response to a so-called remote operation such as a process of remotely opening and closing a door of a vehicle or a process of remotely operating an air conditioner of a vehicle, but is not limited thereto. The timer start process includes, for example, a process of executing a data collection function of periodically sending the state of the vehicle to the information processing device 30, but is not limited thereto. Although the number of processes 120 is two in FIG. 3, the number is not limited to two, and may be any number of one or more.

In the present embodiment, the thread 130 is a unit of processing executed in the process 120. Multiple threads 130 may execute concurrently. Although the number of threads 130 is two per one process 120 in FIG. 3, the present disclosure is not limited to this, and may be any number of two or more. In addition, in a case where the execution of one thread 130 needs to wait for the execution of another thread 130 to end (that is, in a case of sequential processing), it is necessary to perform inter-thread communication.

In the present embodiment, the task 140 is a unit of processing executed in the thread 130. The plurality of tasks 140 in each thread 130 cannot be executed at the same time, and are sequentially processed. Although the number of tasks 140 is two per thread 130 in FIG. 3, the number is not limited to this, and any number of one or more per thread 130 and the total number of tasks 140 in all threads 130 may be any number of three or more.

### Details of the Embodiments

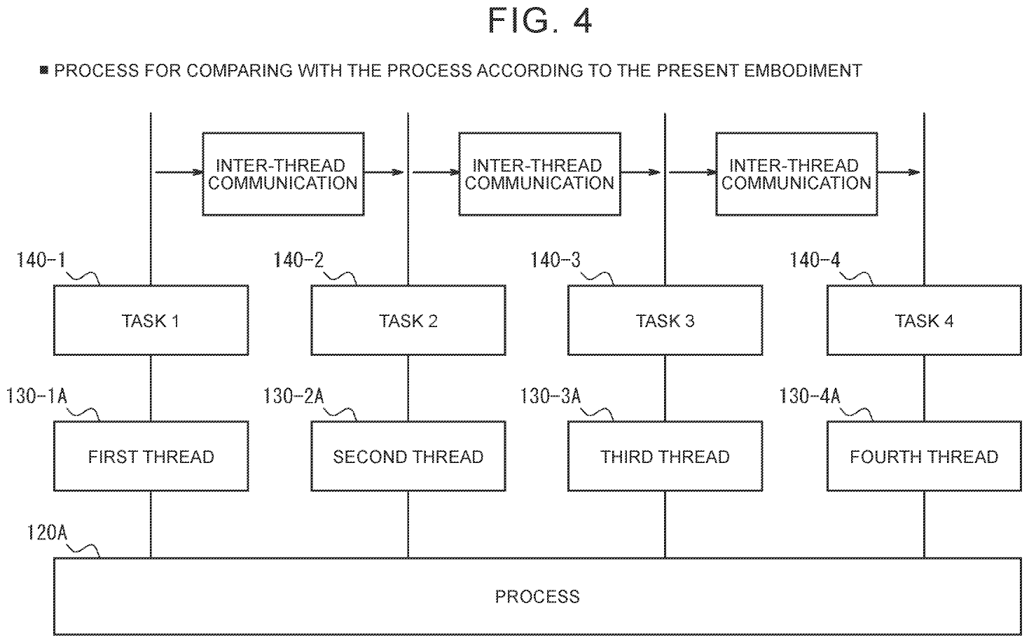

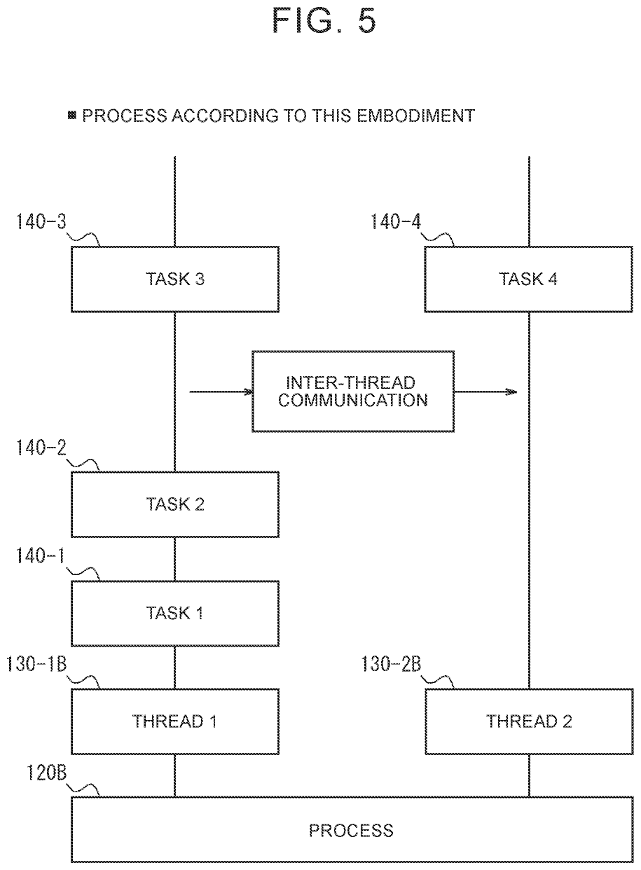

Next, details of the present embodiment will be described using an example of the process 120 of the in-vehicle device 10 illustrated in FIGS. 4 and 5.

As shown in FIGS. 4 and 5, an example in which four tasks 140-1 to 140-4 are generated by one process 120 will be described. Here, it is assumed that the second task 140-2 cannot be executed unless the execution of the first task 140-1 is finished. Further, it is assumed that the third task 140-3 and the fourth task 140-4 cannot be executed unless the execution of the second task 140-2 is completed, and the third task 140-3 and the fourth task 140-4 can be executed simultaneously.

A comparative example shown in FIG. 4 will be described. The process 120A according to the present comparative example is configured to divide the four tasks 140-1 to 140-4 from the four thread 130-1A into 130-4A and process them. Specifically, the process 120A includes a first thread 130-1A having a first task 140-1, a second thread 130-2A having a second task 140-2, a third thread 130-3A having a third task 140-3, and a fourth thread 130-4A having a fourth task 140-4.

In order to execute the second task 140-2, inter-thread communication from the first thread 130-1A to the second thread 130-2A needs to be performed after the execution of the first task 140-1 is completed. In order to execute the third task 140-3, inter-thread communication from the second thread 130-2A to the third thread 130-3A needs to be performed. In order to execute the fourth task 140-4, inter-thread communication from the third thread 130-3A to the fourth thread 130-4A needs to be performed. Therefore, a total of three threads communicate with each other.

On the other hand, the process 120B according to the present embodiment in FIG. 5 is configured to process four tasks 140-1 to 140-4 by dividing the two thread 130-1B into 130-2B. Specifically, the process 120B includes a first thread 130-1B having a first task 140-1, a second task 140-2, and a third task 140-3, and a second thread 130-2B having a fourth task 140-4. In the present embodiment, the first task 140-1, the second task 140-2, and the third task 140-3 are sequentially processed. As described above, the process 120 may be configured to process a plurality of tasks 140 to be sequentially processed by the same thread 130.

In this case, the inter-thread communication that occurs is only the inter-thread communication from the first thread 130-1B to the second thread 130-2B that needs to be performed in order to execute the fourth task 140-4. Therefore, the number of inter-thread communication is smaller than that of the process 120A according to the comparative embodiment, and consequently, the process can be executed at a higher speed.

As described above, the in-vehicle device 10 processes one process 120 by a plurality of threads 130. The process 120 is configured to perform at least three N tasks 140, and the process 120 is configured to process the N tasks 140 into a plurality of fewer than N threads 130.

According to this configuration, during the operation of the process 120, since the N tasks 140 are processed by dividing them into a plurality of threads 130 smaller than N, the number of inter-thread communication is reduced as compared with a configuration in which, for example, the N tasks 140 are processed by dividing them into N threads 130. As a result, the execution speed of the process 120 may be higher than that of the in-vehicle device without the present embodiment. Therefore, according to the present embodiment, the technology of the in-vehicle device of the next-generation vehicle is improved in that the execution speed of the process can be improved.

Although the present disclosure has been described above based on the drawings and the embodiments, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the embodiment of FIG. 5, the process 120B is configured to process the four tasks 140-1 to 140-4 separately from the two thread 130-1B to 130-2B, but if the second task 140-2, the three tasks 140-3, and the fourth task 140-4 can be processed simultaneously, they may be processed by three threads instead of two threads. As described above, the process 120 may be configured to process a plurality of tasks 140 that can be processed simultaneously among the N tasks by dividing them into different threads 130. This is because the task 140 that can be processed at the same time may be divided into different threads 130, which may increase the execution speed of the process 120. In addition, the process 120 may be configured such that the number of inter-thread communication is smaller than the configuration in which the N tasks 140 are divided into N threads 130. That is, the process 120 may be configured to perform inter-thread communication one or more times and N-2 times or less while executing the N tasks 140.

Further, for example, an embodiment in which a general-purpose computer functions as the in-vehicle device 10 according to the above-described embodiment is also possible. Specifically, a program describing processing contents for realizing each function of the in-vehicle device 10 according to the above-described embodiment is stored in a memory of a general-purpose computer, and the program is read and executed by a processor. Therefore, the present disclosure can also be realized as a program that can be executed by the processor or a non-transitory computer-readable medium that stores the program.

What is claimed is:

1. An in-vehicle device configured to execute one process in a plurality of threads, wherein the process is configured to execute N tasks that are at least three tasks, and process the N tasks in a plurality of threads fewer than the N tasks.

2. The in-vehicle device according to claim 1, wherein a plurality of simultaneously processible first tasks among the N tasks is processed in different threads.

3. The in-vehicle device according to claim 1, wherein the process is configured to process a plurality of second tasks to be sequentially processed among the N tasks in the same thread.

4. The in-vehicle device according to claim 1, wherein the process is configured to perform thread-to-thread communication one time or more and N-2 times or less while executing the N tasks.

5. A method to be executed by an in-vehicle device configured to execute one process in a plurality of threads,
the process being configured to execute N tasks that are at least three tasks,
the method comprising processing the N tasks in a plurality of threads fewer than the N tasks.
